(19) United States
(12) Patent Application Publication
(10) Pub. No.: US 2011/0085296 A1
(43) Pub. Date: Apr. 14, 2011

(54) Cooling System For A Computer Blade

(76) Inventors: Brandon Rubenstein, Loveland, CO (US); Fred B. Worley, San Jose, CA (US); Roy Zeighami, McKinney, TX (US); Michael R. Krause, Boulder Creek, CA (US)

(21) Appl. No.: 12/579,195

(22) Filed: Oct. 14, 2009

(51) Int. Cl. G06F 1/20; B23P 11/00

(52) U.S. Cl. 361/679.47; 29/428

(57) ABSTRACT

A cooling system for a computer blade is disclosed. The cooling system comprises a main printed circuit (PC) board with at least one component mounted on a top side of the main PC board. A heat transfer plate is located at the first end of the main PC board. An airflow divider is mounted on, and is perpendicular with, the top side of the main PC board. The airflow divider runs in an axis generally parallel with the first side of the main PC board. A lid is coupled to the main PC board thereby enclosing the main PC board, the heat transfer plate and the airflow divider. The lid encloses a first airflow channel running along the first side of the main PC board and a second airflow channel running along the second side of the main PC board. A fan is located on top side of the main PC board in the first airflow channel. The fan is configured to re-circulate air from the second airflow channel through the first airflow channel, past the heat transfer plate, and then back into the second airflow channel.

### BACKGROUND

Many datacenters are now populated with computer blades mounted in blade enclosures. A computer blade is defined as a device that accesses power and connections to other blades and devices through a shared infrastructure or enclosure. The computer blade may be rack mounted into the enclosure. A computer blade may also be defined as a device that provides power and connectivity to other blades and devices through the shared infrastructure or enclosure. A computer blade can fulfill a number of different functions. There are blade servers, Input/Output (I/O) blades, memory blades, power supply blades, I/O interconnect blades, and the like. As the computer blades have increased in power density, cooling the blades has become a challenge.

Blades are typically cooled by drawing ambient air through the blade enclosure to remove the heat generated by the components mounted on the blades. This solution requires the ambient air to be conditioned to a specific temperature and humidity. Without conditioning, the components may be subject to insufficient cooling, humidity damage, or contamination. Conditioning the air can use a significant portion of the energy required by the datacenter.

### BRIEF DESCRIPTION OF THE DRAWINGS

FIG. 1 is an isometric view of a computer blade 100 in an example embodiment of the invention.

FIG. 2 is an isometric view of a blade lid 200 in an example embodiment of the invention.

FIG. 3A is an isometric view of blade enclosure assembly 300 in an example embodiment of the invention.

FIG. 3B is a cut-away top view of blade enclosure assembly 300 in an example embodiment of the invention.

FIG. 4 is a flowchart for a method of cooling an enclosed blade in an example embodiment of the invention.

### DETAILED DESCRIPTION

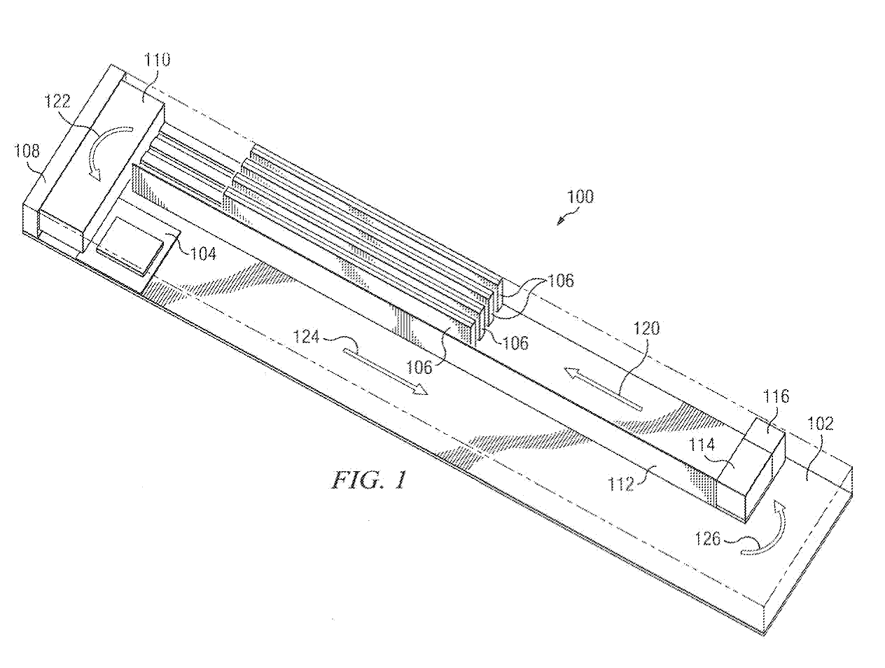

FIGS. 1-4, and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

FIG. 1 is an isometric view of a computer blade 100 in an example embodiment of the invention. Computer blade 100 comprises printed circuit (PC) board 102, high power component 104, dual inline memory modules (DIMM's) 106, heat transfer plate 108, cooling fins 110, airflow divider 112, fan 114, and spacer 116. PC board 102 is generally rectangular in shape with the heat transfer plate 108 mounted at one end of the PC board 102. PC board 102 may include a bottom panel that supports PC board, but the bottom panel is not shown for clarity. Heat transfer plate 108 is generally a rectangular plate positioned perpendicular to the top surface of PC board 102, and parallel with the first end of PC board 102. Cooling fins 110 are attached to heat transfer plate 108 and are mounted with channels or gaps between the fins running parallel with the top surface of the PC board 102. Heat transfer plate and cooling fins may be fabricated from any suitable material having a large thermal conductivity, for example aluminum, copper, or the like. In one example embodiment of the invention, heat transfer plate 108 and fins 110 may be fabricated as a single part.

Airflow divider 112 is mounted on, and is perpendicular with, the top surface of PC board 102. Airflow divider runs generally down the length of PC board 102. Airflow divider 112 creates a re-circulating airflow path down one side of blade 100 and up the other side of blade 100. Re-circulating airflow path flows down a first airflow channel 120 on one side of PC board 102. Re-circulating airflow path passes through the channels or gaps in cooling fins 110 (shown by arrow 122). Re-circulating airflow path flows up a second airflow channel 124 on the other side of PC board 102. Re-circulating airflow path flows around the second end of PC board 102 (shown by arrow 126) and back into the first airflow channel 120. Fan 114 is mounted on the top surface of PC board 102 in the first airflow channel 120. When fan 114 is not as wide as the first airflow channel 120, spacer 116 may be used to fill the gap between the edge of fan 114 and the side of PC board 102.

Airflow divider can be fabricated out of sheet metal, plastic, or the like. In one example embodiment of the invention, airflow divider may be a PC board assembly electrically connected to, and perpendicular with, PC board 102.

High power component 104 is mounted on the top side of PC board 102 in the second airflow channel 124 near cooling fins 110. DIMMs 106 are mounted on the top side of PC board 102 in the first airflow channel 120. DIMMs 106 are mounted in a side-by-side relationship, parallel with the first airflow channel 120. Other components may also be mounted on the top side of PC board 102. Fan 114 forces air to flow through the re-circulating airflow path. Air flowing through the first airflow channel 120 flows between DIMMs 106. Heat generated by DIMMs 106 is transferred to the air flowing past DIMMs 106. Fan 114 forces the air from the first airflow channel through the gaps in cooling fins 110. Cooling fins 110 cool the air flowing through the gaps between the cooling fins 110. Cooling fins 110 transfer the heat from the air to heat transfer plate 108. Heat is removed from the heat transfer plate as discussed below.

The air cooled by cooling fins 110 flows into the second airflow channel 124. The cooled air in the second airflow channel passes over high power component 104. Heat generated by the high power component 104 is transferred into the cooled air flowing past high power component 104. In one example embodiment of the invention, high power component is located in the second airflow channel near cooling fins 110 and therefore receives the airflow when the air is near its coolest. Because the air is near its coolest when passing over high power component 104, cooling is maximized for the high power component 104. Fan 114 forces air flowing in the second airflow channel 124 around the second end of PC board 102 (shown by arrow 126) and back into the first airflow channel 120.

In one example embodiment of the invention, high power component 104 may be cooled using heat pipes in addition to the air flowing through the re-circulating airflow pathway. One end (the hot end) of the heat pipes would be positioned on top of the high power component 104, with the other end (the cool end) of the heat pipe coupled to the cooling fins 110, or coupled directly to the heat transfer plate 108. A heat spreader may be attached to the top side of high power component 104 to aid in the transfer of heat from the high power component 104 into the heat pipes. In other example embodiments the heat pipe may be replaced with a loop thermosiphon, bubble pump, or other similar technology that allows heat to be transferred across some distance. In this application, the term heat pipe will be used to represent any one of these technologies.

In one example embodiment of the invention, a blade lid is mounted onto the PC board 102. FIG. 2 is an isometric view of a blade lid 200 in an example embodiment of the invention. Blade lid 200 comprises a top side 234, an end plate 230, and two side plates 232. Blade lid may be manufactured using sheet metal, plastic, or the like. The open end of blade lid 200 mounts around heat transfer plate 108. The two side plates 232 mount to the two sides of PC board 102. The end plate 230 mounts to the end of PC board 102 opposite the heat transfer plate 108. The bottom surface of the top side 234 of blade lid 200 may contact the top of airflow divider 112 and/or the top surface of fan 114. Blade lid 200 mounts to blade 100 and encloses the first and second airflow channels (120 and 124) thereby forming the re-circulating airflow pathway. In other example embodiments of the invention, side plates 234 and end plate 230, may be separate parts and may attach to PC board 102 or to a bottom plate (not shown) that supports PC board 102.

In one example embodiment, blade lid 200 may not make an air tight seal against PC board 102, as some leakage between the re-circulating airflow pathway and the outside of the blade may be tolerated. In another example embodiment of the invention, blade lid may make an air tight seal preventing air circulation between the blade and the enclosure. In this embodiment, the air inside the enclosure may have higher variations in temperature, humidity, and particle count.

Blade 100 is typically rack mounted into a blade enclosure. There may be a plurality of blades mounted into the blade enclosure. Blade 100 may be any type of blade, for example a blade server, a memory blade, an input/output (I/O) blade, a fabric blade, a graphics blade, or the like. Blade 100 may also be a power supply mounted into a blade enclosure and configured to supply power to other blades mounted in the blade enclosure. When blade 100 is a power supply, power transformers and the like will be the components mounted in the airflow channels, not the high power component 104 or DIMMs 106.

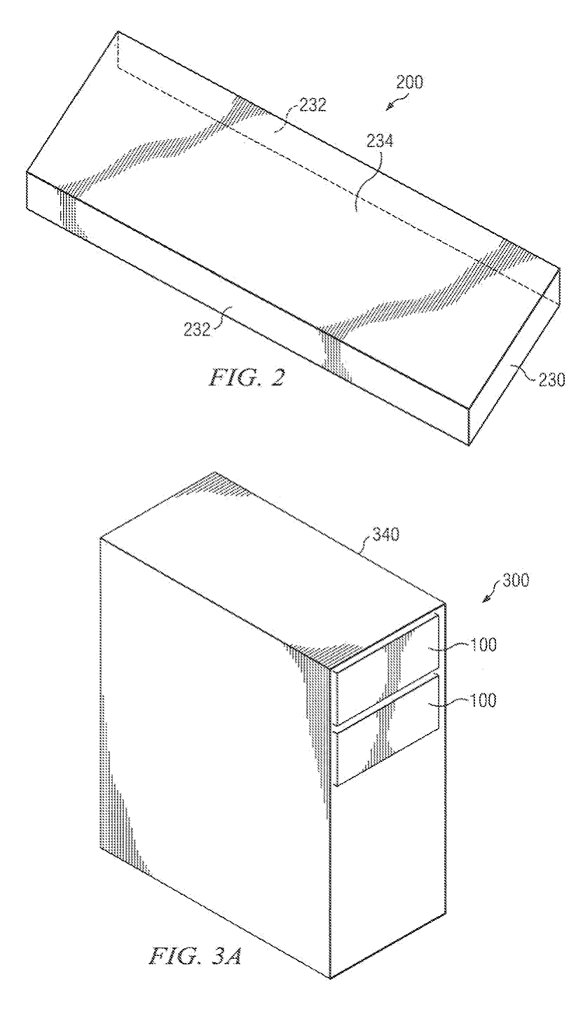

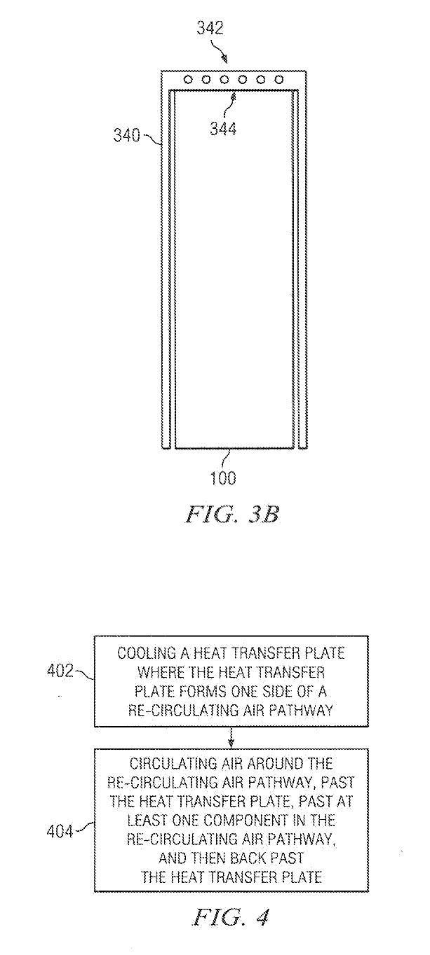

FIG. 3A is an isometric view of blade enclosure assembly 300 in an example embodiment of the invention. Blade enclosure assembly 300 comprises a blade enclosure 340 and a plurality of blades 100 mounted into blade enclosure 340. FIG. 3B is a cut-away top view of blade enclosure assembly 300 in an example embodiment of the invention. FIG. 3B shows one of the plurality of blades 100 inserted into blade enclosure 340. The heat transfer plate 108 on blade 100 makes thermal contact with the inside surface 344 of the back side 342 of blade enclosure. A thermal interface material such as grease may be used to increase the thermal coupling between heat transfer plate 108 and the inside surface 344 of the back side 342 of blade enclosure 340. In another example embodiment of the invention, the inside surface 344 of blade enclosure 340, and the mating surface of heat transfer plate 108, may have ridges or other surface features used to maximize the contact area between the two parts.

The back side 342 of blade enclosure 340 has a plurality of liquid cooling channels coupled to a cooling system that removes heat from the back side 342 of blade enclosure 340. The cooled back side 342 of the blade enclosure 340 transfers heat away from the heat transfer plate 108 on blade 100. In other example embodiments, chilled air may be used to cool the back side 342 of blade enclosure 340. In another example embodiment of the invention, the sides of blade enclosure 340 may be cooled, and one or more heat transfer plates 108 mounted onto the sides of PC board 102 would be thermally coupled to the cooled sides of blade enclosure 340.

In one example embodiment of the invention, blade 100 is enclosed using a lid 200 or other individual parts that mount directly to blade 100 (as discussed above). In another example embodiment of the invention, the sides and top surface of blade enclosure 340 may act as the lid to enclose the air channels and create the re-circulating air pathway for blade 100. In this example, blade 100 may provide an end plate to block the end of the re-circulating air pathway. Or a front door (not shown) may be attached to blade enclosure 340 and used to block the end of the re-circulating air pathway.

FIG. 4 is a flowchart for a method of cooling an enclosed blade in an example embodiment of the invention. The method starts at step 402. In step 402 a heat transfer plate is cooled, where the heat transfer plate forms at least one side of a re-circulating air pathway. At step 404 air is circulated around the re-circulating air pathway, past the heat transfer plate, past at least one component mounted in the re-circulating air pathway, and then back past the heat transfer plate, thereby transferring heat from the component to the heat transfer plate.

What is claimed is:

1. A cooling system for a computer blade, comprising:
a main printed circuit (PC) board with at least one component mounted on a top side of the main PC board, the main PC board being generally rectangular in shape and having a first end and a second end opposite the first end, a first side and a second side opposite the first side;
a heat transfer plate located at the first end of the main PC board wherein the heat transfer plate is generally rectangular in shape and is parallel with the first end of the main PC board and perpendicular to the top side of the main PC board;
an airflow divider mounted on, and perpendicular with, the top side of the main PC board, wherein the airflow divider runs in an axis generally parallel with the first side of the main PC board;
a lid coupled to the main PC board thereby enclosing the main PC board, the heat transfer plate and the airflow divider and thereby creating a first airflow channel running along the first side of the main PC board and a second airflow channel running along the second side of the main PC board;
a fan located on top side of the main PC board in the first airflow channel wherein the fan is configured to re-circulate air from the second airflow channel through the first airflow channel, past the heat transfer plate, and then back into the second airflow channel.

2. The cooling system for a computer blade of claim 1, further comprising:
a blade enclosure having a plurality of mounting slots configured to accept the computer blade;
a back side of the blade enclosure configured to contact, and thermally mate with, the heat transfer plate when the computer blade is mounted into one of the plurality of mounting slots;
a cooling system coupled to the back side of the blade enclosure and configured to cool the back side of the blade enclosure.

3. The cooling system for a computer blade of claim 2, wherein at least one side of the lid is formed by the blade enclosure.

4. The cooling system for a computer blade of claim 1, wherein the lid provides an air tight seal when enclosing the main PC board, the heat transfer plate and the airflow divider.

5. The cooling system for a computer blade of claim 1, further comprising:
at least one heat pipe with a first end thermally coupled to the heat transfer plate and a second end thermally coupled to the at least one component.

6. The cooling system for a computer blade of claim 1, further comprising:
fins mounted onto a first side of the heat transfer plate where the first side of the heat transfer plate faces towards the second end of the main PC board.

7. The cooling system for a computer blade of claim 1, wherein the at least one component is a high power component and is mounted near the heat transfer plate in the second airflow channel.

8. The cooling system for a computer blade of claim 1, wherein the computer blade is selected from one of the following types of computer blades: a server blade, a memory blade, an input/output (I/O) blade, a blade fabric, interconnect fabric blade, and a power supply blade.

9. The cooling system for a computer blade of claim 1, wherein the airflow divider is a second PC board electrically coupled to the main PC board.

10. A method for cooling an enclosed computer blade, comprising:
cooling a heat transfer plate wherein the heat transfer plate forms at least one side of a re-circulating air pathway in the enclosed computer blade;
circulating air inside the re-circulating air pathway past at least one component mounted in the re-circulating air pathway, and then past the heat transfer plate, and then back past the at least one component.

11. The method for cooling an enclosed computer blade of claim 10, wherein the computer blade is selected from one of the following types of computer blades: a server blade, a memory blade, an input/output (I/O) blade, a blade fabric, interconnect fabric blade, and a power supply blade.

12. The method for cooling an enclosed computer blade of claim 10, further comprising:
cooling a first end of at least one heat pipe with the heat transfer plate wherein a second end of the at least one heat pipe is thermally coupled to the at least one component.

13. The method for cooling an enclosed computer blade of claim 10, further comprising:
mounting the enclosed computer blade into a blade enclosure thereby thermally coupling the heat transfer plate to a cold plate in the blade enclosure.

14. A method for manufacturing a computer blade, comprising:
mounting a heat transfer plate at one end of, and perpendicular to, a printed circuit (PC) board;
mounting a airflow divider onto a top side of, and perpendicular with, the PC board wherein the airflow divider runs parallel with a first side of the PC board and creates a first airflow channel on the first side of the PC board and crates a second airflow channel on a second side of the PC board;
mounting a fan in the first airflow channel;
enclosing the PC board with a lid thereby creating a re-circulating air pathway that runs through the first airflow channel, past the heat transfer plate, into the second airflow channel, and then back into the first airflow channel.

15. The method for manufacturing a computer blade of claim 14, further comprising:
thermally coupling a first end of at least one heat pipe with the heat transfer plate and thermally coupling a second end of the at least one heat pipe to a component mounted onto a top side of the PC board in the re-circulating airflow pathway.

16. The method for manufacturing a computer blade of claim 14, further comprising:
mounting fins onto a first side of the heat transfer plate where the first side of the heat transfer plate faces towards the airflow divider.

17. The method for manufacturing a computer blade of claim 14, wherein the computer blade is selected from one of the following types of computer blades: a server blade, a memory blade, an input/output (I/O) blade, a blade fabric, interconnect fabric blade, and a power supply blade.

18. The method for manufacturing a computer blade of claim 14, wherein the airflow divider is a second PC board electrically coupled to the PC board.
